(19) United States
(12) Patent Application Publication
(10) Pub. No.: US 2007/0036338 A1
(43) Pub. Date: Feb. 15, 2007

(54) Telephone adapter for indicating status of telephone

(75) Inventors: Chen-Chi Fan, Tu-Cheng (TW); Hui-Lang Lee, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/300,237

(22) Filed: Dec. 14, 2005

(30) Foreign Application Priority Data
Jun. 24, 2005 (CN) 200510035544.2

(51) Int. Cl. H04M 1/00

(52) U.S. Cl. 379/399.01

(57) ABSTRACT

A telephone adapter (10) connected between a local telephone set (20) and a network (30) includes a processor (130), a subscriber line interface circuit (SLIC) (100) and plural indicating groups (152, 154, 156). The indicating groups connected to the processor, indicate status of the local telephone set. When detecting status of the local telephone set, the SLIC sends status signals to the processor. The processor generates first control signals according to the status signals, and sends the first control signals to the indicating groups. When receiving communication signals from the network, the processor processes the signals, and generates first and second control signals. The processor sends the second control signals to the local telephone set via the SLIC to make the local telephone set act correspondingly. The processor sends the first control signals to the indicating groups to drive the indicating groups to indicate the status of the local telephone set.

### BACKGROUND

1. Field of the Invention

The present invention pertains to telephone adapters, and particularly to a telephone adapter indicating communication and related statuses of a telephone.

2. Related Art

Internet telephony provides communication services via the Internet instead of the Public Switched Telephone Network (PSTN). The main advantage of an internet telephone service is that its charges are much lower than those of PSTN phone services, especially for long distance or overseas calls. Therefore, the internet telephone has become popular. By connecting a conventional telephone set to a telephone adapter, a user of the PSTN can receive a call from the Internet or send a call via the Internet using the conventional telephone set.

However, internet telephone services are liable to be unstable. If the Internet is busy and slow, an ongoing call may be affected, and voice transmission can be delayed. The parties to the call may then operate the internet phone equipment improperly. This is inconvenient and troublesome for the parties. For instance, when a user of the internet telephone is on a call via the Internet and the Internet is busy and slow, voice data transmission may be interrupted. The user may mistakenly think the call has been cut off, and therefore hang up the phone. A conventional telephone set and telephone adapter do not indicate a status of the internet telephone, and users are apt to operate the internet phone improperly and even miss important calls.

Therefore, a heretofore unaddressed need exists in the industry to overcome the aforementioned deficiencies and inadequacies.

### SUMMARY

An embodiment of the present invention provides a telephone adapter connected between a telephone set and a communication network. The telephone adapter includes a processor, a subscriber line interface circuit (SLIC) and a plurality of indicating groups. The indicating groups, connected to the processor, are used for indicating status of the telephone set. When the SLIC detects a status of the telephone set, the SLIC sends status signals to the processor. The processor generates first control signals according to the status signals, and sends the first control signals to the indicating groups to control the indicating groups for indicating the status of the telephone set. When the processor receives a communication signal from the communication network, the processor processes the communication signals, and generates the first control signals and second control signals. The processor sends the first control signals to the indicating groups to activate and control the indicating groups for indicating the status of the telephone set. The processor sends the second control signals to the telephone set via the SLIC, and the telephone set operates according to the second control signals.

Accordingly, users can clearly know the status of the telephone set, such as a ringing status, an off-hook status, and a communicating status. The users can thus avoiding missing or mishandling internet phone calls.

Other advantages and novel features will become more apparent from the following detailed description when taken in conjunction with the accompanying drawings, in which:

### BRIEF DESCRIPTION OF THE DRAWINGS

FIG. 1 is a block diagram of a communication network that includes an exemplary embodiment of a telephone adapter of the present invention; and

FIG. 2 is a block diagram of an embodiment of the telephone adapter of the invention.

### DETAILED DESCRIPTION OF THE EMBODIMENTS

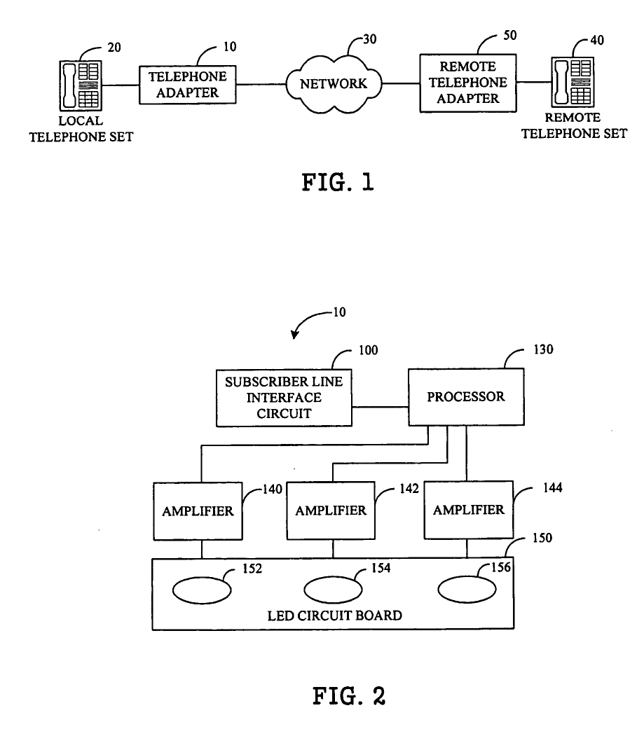

FIG. 1 is a block diagram of a communication network that includes an exemplary embodiment of a telephone adapter 10 of the present invention. The telephone adapter 10 is connected between a local telephone set 20 and a network 30, and is further connected to another telephone adapter 50 via the network 30. The telephone adapter 50 is a remote telephone adapter connected to a remote telephone set 40. With the telephone adapter 10 and the remote telephone adapter 50, the local telephone set 20 can receive internet telephone calls from the remote telephone set 40 via the network 30. In the embodiment, the network 30 includes a communication network such as an Internet Protocol (IP) network, a Public Switched Telephone Network (PSTN), or a wireless network. In the following description of the embodiment, the telephone adapter 10 is an internet telephone adapter connected to an IP network.

FIG. 2 is a block diagram of the telephone adapter 10. In the embodiment, the telephone adapter 10 includes a subscriber line interface circuit (SLIC) 100, a processor 130, and a plurality of indicating groups 152, 154, and 156. In the embodiment, the indicating groups 152, 154, and 156 are light-emitting diode (LED) modules 152, 154, and 156, respectively. The LED groups 152, 154, and 156 each include a plurality of LEDs. The SLIC 100 is connected to the local telephone set 20 (see FIG. 1), and is used for amplifying a ringing signal received from the processor 130, and sending an amplified ringing signal to the local telephone set 20. The SLIC 100 is also used for detecting a status of the local telephone set 20, and for sending status signals to notify the processor 130. In the embodiment, the status signals received by the processor 130 include an off-hook signal, a dialing signal, and a hanging up signal.

The processor 130 is used for receiving communication signals from the network 30 and sending communication signals to the network 30. The processor 130 is also used for controlling the LED groups 152, 154, and 156 to indicate different statuses of the local telephone set 20. In the embodiment, the communication signals received by the processor 130 from the network 30 include a connection request signal, a connection established signal, and a disconnection signal. When the processor 130 receives a communication signal from the network 30, the processor 130 processes the received signal, and generates a first control signal and a second control signal correspondingly. The processor 130 sends the first control signal to the LED groups 152, 154, and 156, in order to activate and control the LED groups 152, 154, and 156 to indicate the status of the local telephone set 20. At the same time, the processor 130 sends the second control signal to the local telephone set 20 via the SLIC 100, so that the local telephone set 20 operates correspondingly.

When the processor 130 receives the status signals sent by the SLIC 100, the processor 130 processes the status signals, and generates first control signals to drive the LED groups 152, 154, and 156 to indicate the status of the local telephone set 20. In the embodiment, the LED groups 152, 154, and 156 are on a circuit board 150, and are respectively connected to the processor 130. In the embodiment, the LED group 152 is used for indicating a ringing status of the local telephone set 20, the LED group 154 is used for indicating an off-hook status of the local telephone set 20, and the LED group 156 is used for indicating a communicating status of the local telephone set 20.

Each LED group 152, 154, and 156 emits a different color of light. In the embodiment, the LED group 152 emits red light, the LED group 154 emits blue light, and the LED group 156 emits yellow light, in order to distinctly indicate the status of the local telephone set 20. In other embodiments of the invention, the LED groups 152, 154, and 156 can comprise LEDs emitting other colors. Users can clearly know the status of the local telephone set 20 by selecting different LEDs for the LED groups 152, 154, and 156.

In another embodiment, the telephone adapter 10 further includes three amplifiers 140, 142, and 144. The amplifiers 140, 142, and 144 are respectively connected between the processor 130 and the LED groups 152, 154, and 156, and are used for amplifying the first control signals and sending amplified first control signals to the LED groups 152, 154, and 156 to enhance the brightnesses of the LED groups 152, 154, and 156.

In other embodiments, the numbers of the LEDs of the LED groups 152, 154, and 156 and the numbers of the amplifiers 140, 142, and 144 can be changed according to different requirements of users.

When the remote telephone set 40 is calling the local telephone set 20 via the network 30, the processor 130 receives the connection request signal from the network 30. The processor 130 processes the connection request signal, generates a second control signal, and sends the second control signal to the local telephone set 20 via the SLIC 100 to make the local telephone set 20 ring. At the same time, the processor 130 generates a first control signal, and sends the first control signal to the amplifier 140. The amplifier 140 amplifies the first control signal, and sends the amplified first control signal to the LED group 152 to light up the LED group 152 to indicate that the local telephone set 20 is ringing.

At this time, if the local telephone set 20 is taken off the hook, the SLIC 100 detects that the local telephone set 20 is in the off-hook position for placing phone calls or answering incoming calls, and sends the off-hook signal to the processor 130. The processor 130 is informed that the connection is completed by the off-hook signal, and notifies the remote telephone set 40 that the connection is established. At the same time, the processor 130 generates another first control signal, and sends the first control signal to the LED group 152 via the amplifier 140 to shut off the LED group 152. The processor 130 also sends a first control signal to the LED group 154 via the amplifier 142 to light up the LED group 154. Subsequently, the remote telephone set 40 and the local telephone set 20 begin to communicate, and the processor 130 generates another first control signal, and sends the first control signal to the LED group 156 via the amplifier 144 to light up the LED group 156. During the phone call, the LED groups 154 and 156 are both lit up. When the processor 130 receives the disconnecting signal from the network 30, the processor 130 is thus informed that the remote telephone set 40 has terminated the connection, and generates another first control signal and second control signal. The processor 130 sends the first control signal to the LED group 156 via the amplifier 144 to shut off the LED group 156. The processor 130 sends the second control signal to the local telephone set 20 via the SLIC 100 to inform a user to hang up the local telephone set 20.

In the embodiment, if the local telephone set 20 is a caller, when the local telephone set 20 is off the hook, the SLIC 100 detects the off-hook status of local telephone set 20, and sends an off-hook signal to the processor 130. The processor 130 processes the off-hook signal, generates a first control signal, and sends the first control signal to the LED group 154 to light up the LED group 154. When the local telephone set 20 is dialing, the processor 130 receives and processes a dialing signal from the SLIC 100, generates a connection request package, and sends the connection request package to the remote telephone set 40. When the processor 130 receives a connection established signal sent by the remote telephone set 40, the processor 130 processes the connection established signal such that communication can begin, and generates another first control signal to light up the LED group 156. When the local telephone set 20 is communicating with the remote telephone set 40, the LED groups 154 and 156 are both lit up. When the processor 130 receives the disconnecting signal, the processor 130 generates a controlling signal according to the disconnecting signal, and sends the controlling signal to the LED group 156 to shut off the LED group 156.

As long as the local telephone set 20 is off the hook, the LED group 154 is lit up. When the local telephone set 20 is hung up, the SLIC 100 detects this event, and sends a hanging up signal to the processor 130. The processor 130 processes the hanging up signal, and generates a first control signal to shut off the LED group 154.

In another embodiment, the LED groups 152, 154, and 156 can be replaced with other light source modules such as lamps. Every light source module may comprise lamps of different colors to distinctly indicate the ringing, off-hook, and communicating statuses. In other embodiments, the processor 130 may comprise a central processing unit and a digital signal processor.

By connecting the telephone adapter 10 of the embodiment to a conventional telephone set, users can clearly know a status of the local telephone set 20, such as a ringing status, an off-hook status, and a communicating status. Thereby, user can avoid mistakenly hanging up or missing internet phone calls.

While various embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

We claim:

1. A telephone adapter for connecting between a telephone set and a communication network and indicating a status of the telephone set, comprising:
a processor;
a subscriber line interface circuit (SLIC); and
a plurality of indicating groups, connected to the processor, for indicating the status of the telephone set;
wherein when the SLIC detects a status of the telephone set, the SLIC sends a status signal to the processor, and the processor generates and sends one or more first control signals to activate and control one or more of the indicating groups to indicate the status of the telephone set; and
when the processor receives a communication signal from the communication network, the processor processes the communication signal, generates one or more first control signals to activate and control one or more of the indicating groups to indicate the status of the telephone set, generates a second control signal, and sends the second control signal to the telephone set via the SLIC such that the telephone set operates correspondingly.

2. The telephone adapter as claimed in claim 1, wherein the communication signal received by the processor from the communication network comprises any item selected from the group consisting of a connection request signal, a connection established signal, and a disconnection signal.

3. The telephone adapter as claimed in claim 1, wherein the status signal received by the processor from the SLIC comprises any item selected from the group consisting of an off-hook signal, a dialing signal, and a hanging up signal.

4. The telephone adapter as claimed in claim 1, further comprising a plurality of amplifiers connected between the processor and the indicating groups, for amplifying the first control signals sent by the processor, and sending one or more amplified first control signals to one or more of the indicating groups.

5. The telephone adapter as claimed in claim 1, wherein each indicating group comprises at least one visual indicating element, and each visual indicating element emits light.

6. The telephone adapter as claimed in claim 5, wherein the visual indicating element comprises a lighting emitting diode.

7. The telephone adapter as claimed in claim 1, wherein the indicating groups comprise an indicating group for indicating a ringing status of the telephone set.

8. The telephone adapter as claimed in claim 1, wherein the indicating groups comprise an indicating group for indicating an off-hook status of the telephone set.

9. The telephone adapter as claimed in claim 1, wherein the indicating groups comprise an indicating group for indicating a communicating status of the telephone set.

10. A method for indicating communication statuses of a telephone, comprising the steps of:
connecting a telephone with a communication network having communicable remote telephones therein via an adapter;
programming said adapter so as to allow communication statuses of said telephone being retrievable in said adapter; and
indicating said retrieved communication statuses via indicating groups equipped in said adapter.

11. The method as claimed in claim 10, wherein the indicating groups comprise at least one indicating group of light-emitting diodes (LEDs).

12. A method for indicating communication statuses of a telephone, comprising the steps of:
connecting a telephone with at least one digital communication network having communicable remote telephones therein via an adapter;
retrieving communication statuses of said telephone via said at least one digital communication network by using said adapter; and
indicating said retrieved communication statuses by means of indicating groups equipped in said adapter.

13. The method as claimed in claim 12, wherein said digital communication network is an Internet Protocol (IP) network.
